(19) United States
(12) Patent Application Publication
(10) Pub. No.: US 2017/0003837 A1
(43) Pub. Date: Jan. 5, 2017

(54) Systems and Methods for Generating, Presenting, and Adjusting Adjustable Virtual Keyboards

(71) Applicant: Integrated Computer Solutions, Inc., Bedford, MA (US)

(72) Inventors: Dorothy Shamonsky, Lincoln, MA (US); Benjamin Hannon, Salem, NH (US)

(73) Assignee: Integrated Computer Solutions, Inc., Bedford, MA (US)

(21) Appl. No.: 15/199,849

(22) Filed: Jun. 30, 2016

Related U.S. Application Data
(60) Provisional application No. 62/187,011, filed on Jun. 30, 2015.

(51) Int. Cl. G06F 3/0482; G06F 3/0484; G06F 3/0486; G06F 3/0488

(52) U.S. Cl. CPC G06F 3/0482; G06F 3/04886; G06F 3/04883; G06F 3/04845; G06F 3/0486

(57) ABSTRACT

Systems and methods for generating and presenting virtual keyboards for display, and allowing user-selected adjustments to such generation and display, are provided. The system may be a touch-enabled device of any size or number of screens, or may project a virtual keyboard onto a surface or in a region of space. The system accepts control inputs from a user to make one or more adjustments to the keyboard, such as splitting or combining a keyboard into one or more components, and for one or more components, rotation around one or more edges or corners; translational movement; and resizing. The user may use the virtual keyboard or components as an input device at any time. The present invention solves problems with the functioning and usability of computer systems by increasing the efficiency and accuracy of data entry and the user's willingness to use the virtual keyboard, and by reducing user disorientation.

### FIELD OF THE INVENTION

The presently disclosed subject matter relates to virtual keyboards, and more specifically, to systems and methods for generating virtual keyboards, displaying virtual keyboards to a user, accepting control inputs from a user related to the generation and display of the virtual keyboards, adjusting the generation and display of the virtual keyboards in response to said control inputs from a user, and allowing a user to use the virtual keyboards as input devices.

### BACKGROUND OF THE INVENTION

A keyboard is a physical input device, used to enter data as single or combination keystrokes to a computer. A virtual keyboard is a keyboard generated by software on a computer, and displayed to the user, that allows a user to enter some or all of the data that could be entered with a physical keyboard. A virtual keyboard may be displayed on a non-touchscreen computer display, with another input device such as a mouse or a trackpad used to select keys and enter virtual keystrokes. A virtual keyboard may be displayed on a touchscreen display, whether that touchscreen display is external to a computer or integrated into a single computer-and-touchscreen device. A virtual keyboard may be displayed by projection on a flat or curved surface, or holographically in space, or in some instances even invisibly. In all implementations of a virtual keyboard, there is some sensor or sensors—typically capacitative touch sensors for touchscreen virtual keyboards, and optical sensors for projected virtual keyboards.

Virtual keyboards are not limited to only full character-set keyboards, but rather may be presented as a subset of letters, as a number pad, as only special characters (those that are not numbers or letters), as “control” characters such as option, command, shift, tab, and return, among others, or in various pre-set or configurable combinations of the foregoing.

Virtual keyboards are often used on devices where there is no room for a physical keyboard, such as mobile smartphones, tablet computers, and wearable devices. Many such devices, which are all mobile computers, typically have touchscreens and implement virtual keyboards on-screen, though it is possible to use an external projected keyboard with some such mobile computers, or any of various physical external keyboards. Virtual keyboards may also be used on other mobile devices, such as portable gaming units or portable entertainment consoles, which are also mobile computers.

Virtual keyboards are also used on displays for non-mobile computing applications, such as where use of a physical keyboard would interfere with the functioning, safety, cost-effectiveness or appearance intended for the use of that computer. For instance, limited virtual keyboards are sometimes used on touchscreen automated teller machines or public transit fare-purchasing machines, understandably, as a physical keyboard would likely be prone to damage. Virtual keyboards may also be used in retail stores, malls, and showrooms, where large displays can attract the attention of customers and present information, and virtual keyboards can be a simpler and more effective way of gathering input from potential customers. Virtual keyboards may also be used in office or conference settings, at times in a table-top display, for group collaboration or communication. Other applications of virtual keyboards include uses in vehicular control systems, such as the on-board vehicle controls for cabin temperature, controls for lights, navigation, communications, satellite tracking, or other settings available through the computer systems integrated into automobiles, boats, motorcycles, aircraft, or other vehicles. Virtual keyboards may also be integrated into passenger entertainment and communication systems in vehicles, such as seat-back entertainment systems in automobiles and aircraft.

Before high quality touchscreens became relatively affordable, kiosks and other publicly accessible displays typically included physical keyboards or keypads for user input. Such displays now usually have touchscreen interfaces. Entering text using a virtual keyboard or keypad, while standing at a device, can feel awkward depending on the angle and size of the screen. It can also be physically uncomfortable for a user's arms and hands, as input using such a virtual keyboard requires the user to hold arms and hands up and at a particular angle for a period of time, which is known to create arm and hand fatigue. Additionally, the angle of a touchscreen display affects how quickly people perceive the device as interactive or touch-enabled, and the presence of an adjustable virtual keyboard can speed a user's recognition of the display as a touchscreen display, as well as improve efficiency and usability.

Virtual keyboards can have other advantages over physical keyboards. Users with disabilities may not be able to use or be able to access a physical keyboard, whereas a virtual keyboard can be an effective input device. Virtual keyboards can also be effective for users who can or wish to type in more than one language or keyboard layout, as a virtual keyboard can allow switching the character sets or keyboard layout without requiring multiple hardware physical keyboards.

All of the foregoing implementations of virtual keyboards are available only as rectilinear keyboards: a rectangular keyboard with square or rectangular keys arranged in straight rows. Rectilinear physical keyboards can contribute to discomfort and physical injury, such as carpal tunnel syndrome, and can be less efficient for typing than other keyboard layouts. Ergonomic physical keyboards are available, such as ones where the keys are situated in a left-hand set and a right-hand set, with each set's rows of keys angled relative to a rectilinear physical keyboard so that the rows and columns of keys align with a more body-neutral (with regard to flexion or extension) posture of the user's forearms and hands. In such ergonomic physical keyboards, the keys may also be presented in different sizes, aligning better with the reach of a user's hands and fingers. This lack of ergonomic layout is not addressed in current virtual keyboards.

A further problem with the current art in virtual keyboards is that they are not adjustable by the user in any way: they are displayed to the user, and the user must use them at only that size, location on the screen, and orientation on the screen. Users with differently sized hands and fingers will not all be comfortable using an identically sized virtual keyboard.

Additionally, virtual keyboards can lead to user disorientation because they do not appear in perspective, as any physical keyboard does when a user views and uses it. The lack of perspective on a virtual keyboard can, like many classic optical illusions, deceive a user into thinking that the keys in the top row are significantly larger than the keys in the bottom row. This can lead to a reduction in ease of use, less efficient typing by a user, decreased comfort with the virtual keyboard, and decreased desire to use the virtual keyboard on that device at all, reducing or eliminating the advantages of a virtual keyboard on that device.

A further problem with the current art arises from the fact that large touchscreen displays are generally not adjustable at all in terms of location and angle of orientation, about any axis of the display. In contrast to a mobile device, whose designers devoted significant effort towards getting a usable keyboard into a very small space, large touchscreen devices do not have a problem of limited space: they can have spacious keyboards that are placed anywhere on the screen. But, large touchscreens are almost always fixed in a specific location and at a specific angle, so that a user cannot endlessly re-locate and re-orient the device for comfort and usability, as is possible with a mobile device.

The lack of comfort that users feel with virtual keyboards, the relatively lower ease of use of non-adjustable virtual keyboard systems and lower efficiency in typing and data entry, and the possibility of injury such as a repetitive stress injury through use of a rectilinear virtual keyboard are all problems with the current art. They present obstacles to a more widespread and more comfortable use of virtual keyboards, especially on larger displays.

### SUMMARY OF THE INVENTION

The present invention meets all these needs, by disclosing systems and methods for adjustable virtual keyboards. The inventive systems and methods present virtual keyboards that are adjustable by the user, for ergonomics, for efficiency, and for comfort and ease of use, and that can be displayed in multiple perspectives. These possible adjustments to a virtual keyboard disclosed herein improve the functioning and usability of a computer system. These advantages over the prior art can lead to greater comfort and reduced risk of injury, such as from repetitive stress injuries, for the user. The present invention can also lead to increased speed and efficiency in accuracy of input via typing. And, the present invention can reduce user disorientation relative to when viewing a rectilinear keyboard on-screen, leading to increased ease of use, more efficient typing by a user, increased comfort with the virtual keyboard, and increased desire to use the virtual keyboard on that device. The adjustable parameters, of rotation about a first edge, a second edge, or center point; translation for location on the screen; scaling for size of the virtual keyboard; and splitting the virtual keyboard into one or more subunits, allow the user to arrange the virtual keyboard in a way that is comfortable for the user to input text.

For example, a user with smaller hands may find a smaller sized virtual keyboard more comfortable, and a tall user may want to have the keyboard placed higher on the screen or farther from the near edge. Rotating the keyboard around a second edge may make for easier input from multiple people in sequence when several users are crowded around a screen, and on a tabletop touchscreen, a rotating keyboard will greatly increase usability and efficiency.

The present invention, by allowing the user to configure the placement, size and angle of the virtual keyboard, improves on the prior art for usability, comfort, and ease of use, and also solves the immobile-device text input problem by allowing users to adjust the apparent angles of orientation, the size, the location, and the separation of the virtual keyboard into one or more component subunits. The present invention may also be implemented with a plurality of preset options for user adjustment of one or more of the user-adjustable parameters of the virtual keyboard. User adjustment of any of the adjustable parameters may be carried out through tabs attached to and displayed with the virtual keyboard, showing what parameters each tab adjusts. Alternatively, users may adjust any of the adjustable parameters with a range of touch and/or multi-touch gestures, including but not limited to tap-and-hold to move the virtual keyboard or a subunit of the virtual keyboard on the touchscreen display, pinch-or-spread to resize the virtual keyboard, a multi-finger hold-and-swipe or hold-and-rotate to rotate the keyboard or component about any of the edges or corners of that keyboard or component, and a multi-touch gesture to split the virtual keyboard into a plurality of subunits. In other embodiments of the present invention, user adjustment of any of the adjustable parameters may be carried out through a user's selection of a preset position, location, rotation, or split into subunits for the virtual keyboard or a subunit thereof, by means of buttons or contextual menus available with gestures or taps from the virtual keyboard.

The present invention may be implemented in a great range of applications or computer systems, including but not limited to handheld smartphones in a range of sizes, tablet computers, wearable devices, portable entertainment or gaming devices, in-vehicle entertainment or control computer systems, moderate to large touch-screen displays for personal or office computers, purpose-built kiosks such as ATMs, collaboration tools, tabletop displays, and commercial displays or kiosks which may have 40″ or larger touchscreen displays offering customers or passers-by the opportunity to enter information to customize an experience, to search for a product, store, or service, or to obtain more details on a particular topic.

The inventive systems presently disclosed comprise one or more processors, memories, and displays, collectively referred to for simplicity as a computer system, along with a plurality of computer-readable media for storing computer-readable instructions, said computer-readable instructions being capable of modifying and improving the functioning of the said computer system by making one or more virtual keyboards. The said computer system may be any of the foregoing computer systems, or the computer system may be implemented in other ways. The inventive methods presently disclosed comprise a set of computer-readable instructions, to be carried out on a said computer system, suitable for displaying one or more virtual keyboards, and modifying the one or more virtual keyboards in response to user input, said modifications being referred to herein as the user modifications, and comprising a plurality of possible types of modifications, to be further described below.

The inventive systems and methods improve the functioning of the said computer system by making the virtual keyboard input device ergonomically adjustable and adjustable for perspective, resulting in improvements in increased speed and efficiency in accuracy of input via typing, improvements in reduced user disorientation, improvements in increased ease of use, improvements in increased comfort with the virtual keyboard, and improvements in increased desire to use the virtual keyboard. These improvements, collectively referred to herein as the user experience improvements, or “UX improvements,” are improvements to the functioning of a computer system, by making said computer system easier to use, more comfortable to use, and more inviting to use, and are also improvements to the experience of a user of the said computer system. Users strongly tend to hold their hands angled downwards or at small angle when doing physical typing, but typing on a wall-mounted display, or on a table-mounted display, or on a display fixed in a vehicular console, or on a virtual keyboard projected on a surface not at a comfortable angle relative to the user, makes it awkward to type on a virtual keyboard. The presently disclosed adjustable virtual keyboard is effective in improving usability and efficiency on a range of physical touchscreen display angles or angles of the surface on which a virtual keyboard is projected, while reducing user fatigue in arms and hands.

All applications of the present invention provide UX improvements over the present art, in regards to ergonomics, ease and efficiency of use, and the degree to which users wish to continue using the virtual keyboard as an input device. For both personal use applications of the present invention, and commercial display applications, these improvements will provide tangible benefits to the seller or operator of the computer system.

The adjustable virtual keyboard can be implemented in a variety of visual styles, from a relatively plain virtual keyboard similar to those that can be found on a range of mobile devices, to implementations including a three-dimensional virtual keyboard, day and night modes, button glow, and more, as will be apparent to one of skill in the art.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, there is shown in the drawings exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows multiple views of an exemplary virtual keyboard, depicted on an exemplary display, rotated for perspective about a first edge of the virtual keyboard, with FIG. 1A showing an unrotated exemplary virtual keyboard, and FIGS. 1B-1D showing the exemplary virtual keyboard in different virtual perspectives, created by rotating the virtual keyboard around a first edge of the virtual keyboard.

FIG. 2 depicts multiple views of an exemplary virtual keyboard, depicted on an exemplary display, scaled to different sizes, with FIG. 2A depicting a standard sized exemplary virtual keyboard, and FIGS. 2B-2D showing the exemplary virtual keyboard in different sizes, created by scaling the virtual keyboard.

FIG. 3 shows multiple views of an exemplary virtual keyboard, depicted on an exemplary display, rotated around the center point of the virtual keyboard, with FIG. 3A showing an unrotated exemplary virtual keyboard, and FIGS. 3B-3E showing the exemplary virtual keyboard in different virtual perspectives, created by rotating the virtual keyboard around the center point of the virtual keyboard.

FIG. 4 depicts multiple views of an exemplary virtual keyboard, depicted on an exemplary display, as one or more components of a virtual keyboard, with FIG. 4A depicting a standard exemplary virtual keyboard presented in one unit, and FIGS. 4B-4D showing the exemplary virtual keyboard as various pluralities of components, created by separating the virtual keyboard.

FIG. 5 shows multiple views of an exemplary virtual keyboard, depicted on an exemplary display, which may be presented as one or more components of a virtual keyboard, with each component of a virtual keyboard adjusted with one or more of a rotation around a first edge of said component, a scaling of said component, a rotation around the center point of said component, with FIG. 5A showing an exemplary virtual keyboard rotated around a first edge and around the center point, FIG. 5B showing an exemplary virtual keyboard rotated around a first edge and around the center point and separated into a plurality of subunits, FIG. 5C showing an exemplary virtual keyboard rotated around a first edge and around the center point and scaled to a different size, and FIG. 5D showing an exemplary virtual keyboard rotated around a first edge and around the center point, separated into a plurality of subunits, and scaled to a different size.

FIG. 6 shows multiple views of an exemplary virtual keyboard on an exemplary display, which may be moved to a plurality of locations on the touchscreen display, as well as presented with a plurality of rotation around a first edge, scaling, rotation around the center point, and separation into subunits, with FIG. 6A showing an exemplary virtual keyboard located near the bottom of the display at a standard size in one unit with rotation around a first edge and without rotation around the center point; FIG. 6B showing an exemplary virtual keyboard moved along a second edge towards the middle of the touchscreen display, and scaled to a larger size, presented in one unit, and not rotated around a first edge or the center point; FIG. 6C showing an exemplary virtual keyboard located at a side of the touchscreen display, rotated around a first edge for perspective and around the center point to align with the side of the touchscreen display, and scaled to a smaller size, though not separated into multiple subunits; and FIG. 6D showing an exemplary virtual keyboard located at a corner of the touchscreen display, rotated around a first edge for perspective and around the center point to be angled along the corner of the touchscreen display, and scaled to a standard size, and separated into multiple subunits.

FIG. 7 shows an exemplary method of iteratively calculating the presentation of an exemplary virtual keyboard, sending the calculated presentation of the exemplary virtual keyboard to the touchscreen display, accepting user inputs for one or more calculated parameters of the exemplary virtual keyboard, here shown as a first edge rotation, center point rotation, size, and separation into one or more subunits, recalculating the display of the exemplary virtual keyboard based on the user inputs, and re-sending the calculated presentation of the exemplary virtual keyboard to the touchscreen display.

FIG. 8 shows an exemplary system configured to carry out the present invention, comprising a plurality of processors, a plurality of memories, a plurality of displays, and a plurality of computer-readable media for storing computer-readable instructions.

FIG. 9A shows an exemplary method of generating, presenting, and adjusting a virtual keyboard from the perspective of an input device in operative communication with the inventive system.

FIG. 9B depicts an exemplary method of generating, presenting, and adjusting a virtual keyboard from the perspective of a third party external to a system and an input device.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

The present subject matter discloses systems and methods for generating and presenting adjustable virtual keyboards, and for accepting inputs from a user for adjusting and recalculating the virtual keyboard, and recalculating the virtual keyboard to comply with the inputs from a user, and presenting the adjusted virtual keyboard. In the present invention, a processor 810 calculates a first presentation of an exemplary virtual keyboard 110, sends the calculated presentation of the exemplary virtual keyboard 110 to an exemplary display 102, with the virtual keyboard comprising a plurality of adjustment-input indications, which adjustment-input indications correspond to a plurality of possible adjustments, and the processor then waits for and accepts a plurality of user inputs 730 for a plurality of adjustments to the calculated presentation of the exemplary virtual keyboard 110 from a user indicating a desired adjustment. When the processor 810 receives an input for a desired adjustment, the processor 810 makes a plurality of calculations 750 related to a plurality of the adjustments referred to herein as the user modifications, and iteratively calculates 710 a next presentation of an exemplary virtual keyboard 110. In a preferred embodiment of the invention, the plurality of possible adjustments may include, but is not limited to, one or more of the following adjustments to the generation and presentation of a virtual keyboard: rotation about a first edge, a second edge, or a center point; translation for location on the display; scaling for size of the virtual keyboard; and splitting the virtual keyboard into one or more subunits. These adjustments lead to UX improvements as discussed above, namely improvements in increased speed and efficiency in accuracy of input via typing, improvements in reduced user disorientation, improvements in increased ease of use, improvements in increased comfort with the virtual keyboard, and increased desire to use the virtual keyboard. The user inputs may comprise gestural touch commands and/or a plurality of adjustment-input indications including but not limited to control tabs or control buttons, as described in greater detail below.

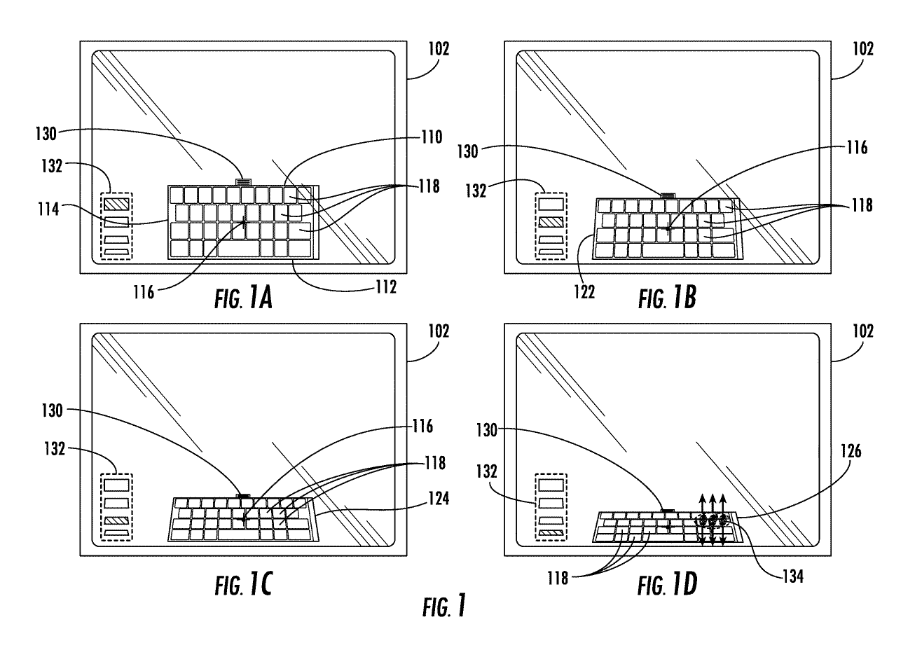

With reference to FIG. 1, an exemplary display 102 is shown with an exemplary virtual keyboard 110 in FIG. 1A. The exemplary virtual keyboard 110 comprises a first edge 112, a second edge 114, a center point 116, and a plurality of keys 118. In some embodiments of the present invention, a virtual keyboard 110 may have a plurality of adjustment-input indications which may comprise a first-edge-control-tab 130, a plurality of first-edge-control-buttons 132, or both a first-edge-control-tab 130 and a plurality of first-edge-control-buttons 132. It is to be understood that while throughout the drawings and disclosure of the present invention, the inventive systems 800 and methods 700 refer to an exemplary display 102, all depictions and descriptions of such a display 102 are not to be taken to limit the types of displays which may be used in implementing the present invention. For example, and without limiting the foregoing, an exemplary display 102: may comprise a touchscreen display of any size; may comprise a plurality of displays, also referred to as screens in this disclosure of the present invention; may be projected onto a surface; may be projected holographically or by other means into or onto a three-dimensional volume; or may be a display of another type.

In this embodiment of the present invention, the virtual keyboard 110 may be rotated about a first edge 112, creating an apparent perspective of the virtual keyboard 110, as shown by virtual keyboard 122 in FIG. 1B. It is important to note that in embodiments of the present invention in which the virtual keyboard 110 is presented on a flat display 102, any rotation discussed in the present disclosure is a virtual rotation: the virtual keyboard 110 remains flat on the display 102, but the presentation of the virtual keyboard 110 shifts from a rectilinear shape to a trapezoidal shape or components of a trapezoidal shape, suggesting apparent rotation through the use of single-point perspective, or in similar rotations around a different virtual axis of the display 102, the virtual keyboard 110 appears to rotate around any such other virtual axis. All uses of the terms “rotation”, “rotate”, “rotated”, “perspective”, and similar terms are to be understood in this context. If the virtual keyboard 122 is presented in a holographic or other non-flat display, the rotations may be a change of perspective as described above, or may alter the 3-dimensional shape of the virtual keyboard 122, or may combine both of those types of changes to the shape of the virtual keyboard 122.

FIG. 1C shows the exemplary virtual keyboard 110 further rotated about a first edge 112 to be displayed as virtual keyboard 124, and FIG. 1D depicts the exemplary virtual keyboard 110 yet further rotated about a first edge 112 to be displayed as virtual keyboard 126.

With reference to each of FIGS. 1A-1D, the rotation of a virtual keyboard 110 about a first edge 112 may be controlled by a first-edge-control-tab 130, with the user of the virtual keyboard 110 using a tap-and-drag gesture perpendicular to a first edge 112 of the virtual keyboard 110, or other gesture control on a touch-enabled device, to move the first-edge-control-tab 130 on the display 102 relative to a first edge 112. The inventive system 800 calculates a new shape for the virtual keyboard 110 based on the distance between a first edge 112 of the virtual keyboard 110 and where the user positions or releases the first-edge-control-tab 130. The system 800 then rapidly re-displays the virtual keyboard 110 as virtual keyboard 122, virtual keyboard 124, virtual keyboard 126, or another shape modifying virtual keyboard 110 to a trapezoid or portion of a trapezoid.

In some embodiments of the present invention, the virtual keyboard 110 may further comprise a plurality of first-edge-control-buttons 132, with each of the plurality of first-edge-control-buttons 132 inputting to the system 800 a particular trapezoidal shape of a modified virtual keyboard 110, allowing the user to rapidly choose between different perspectives of an unrotated or rotated exemplary virtual keyboard, including but not limited to virtual keyboard 110, virtual keyboard 122, virtual keyboard 124, virtual keyboard 126, or another shape modifying virtual keyboard 110 to a trapezoid or portion of a trapezoid, by tapping any of the plurality of first-edge-control-buttons 132. In some embodiments of the present invention, a plurality of the first-edge-control-buttons 132 may be set by a user to present particular perspective views of an exemplary virtual keyboard 110. The placements of the first-edge-control-tab 130 and of the plurality of first-edge-control-buttons 132 in these or other illustrations are purely for exemplary purposes, and other placements of these or other portions of the virtual keyboard 110 are to be understood as possible and desirable, as will be obvious to one of skill in the art.

In a preferred embodiment of the present invention, the rotation of a virtual keyboard 110 about a first edge 112 may be controlled by dedicated gestural touch commands, whether recognized by the system 800 only when the gestural touch commands are performed in the touchscreen area of the virtual keyboard 110, or at any location on the display 102. By way of example, without limiting the type or nature of any such gestural touch commands, the system 800 may be configured to recognize a three-point touch-and-drag gesture 140, as depicted in FIG. 1D, as a user input controlling the apparent perspective created by rotating the virtual keyboard 110 about a first edge 112, based on the distance from the first edge 112 at which the user releases the touch-and-drag gesture 140.

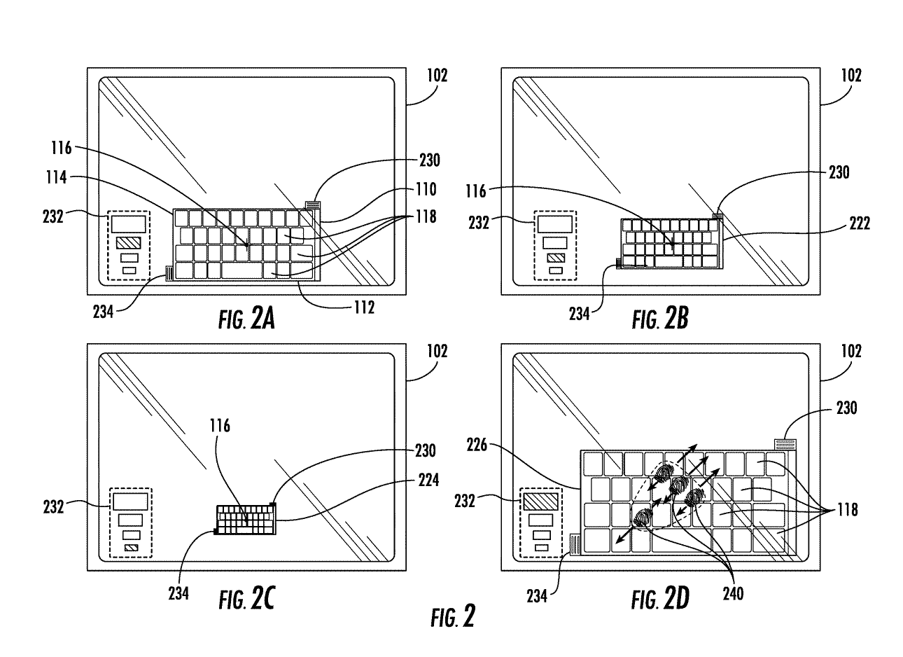

In FIG. 2, an exemplary display 102 is shown with an exemplary virtual keyboard 110 in FIG. 2A. In a preferred embodiment of the invention, the virtual keyboard 110 may be scaled, also referred to as resized, to be presented as a virtual keyboard 110 in a range of sizes, as shown by virtual keyboard 222 in FIG. 2B, virtual keyboard 224 in FIG. 2C, and virtual keyboard 226 in FIG. 2D, all presented for exemplary purposes on an exemplary display 102, with the exemplary display 102 shown at the same size to illustrate the scaling of the virtual keyboards relative to the exemplary display 102.

With reference to each of FIGS. 2A-2D, the scaling of a virtual keyboard 110 may be controlled by a plurality of adjustment-input indications, including but not limited to a first scaling-control-tab 230. In a preferred embodiment of the invention, the user of the virtual keyboard 110 uses a tap-and-drag gesture on the first scaling-control-tab 230 away from or towards the center point 116, or other reference point or points, including but not limited to a first edge 112 of the virtual keyboard 110, or other gesture control on a touch-enabled device, to move the first scaling-control-tab 230 on the display 102 relative to the center point 116 or other reference point of the virtual keyboard 110. The inventive system 800 calculates a new size for the virtual keyboard 110 based on the distance between the center point 116 or other reference point of the virtual keyboard 110, and where the user positions or releases the first scaling-control-tab 230. The system 800 then rapidly re-displays the virtual keyboard 110 as virtual keyboard 222, virtual keyboard 224, virtual keyboard 226, or another size modifying virtual keyboard 110. In other embodiments of the invention, the virtual keyboard 110 may comprise a second scaling-control-tab 234. A user may be able to scale the virtual keyboard 110 by using either a first scaling-control-tab 230 or a second scaling-control-tab 234 in a manner similar to that described above for a first scaling-control-tab 230. In yet other embodiments of the present invention, a user may perform touch gestures on more than one of the first scaling-control-tab 230 and the second scaling-control-tab 234 simultaneously to scale the virtual keyboard 110. It may be desirable to have a plurality of scaling-control-tabs.

In some embodiments of the present invention, the plurality of adjustment-input indications of the virtual keyboard 110 may further comprise a plurality of scaling-control-buttons 232, with each of the plurality of scaling-control-buttons 232 inputting to the system 800 a particular size of a modified virtual keyboard 110, allowing the user to rapidly choose between different sizes of an exemplary virtual keyboard, including but not limited to virtual keyboard 110, virtual keyboard 222, virtual keyboard 224, virtual keyboard 226, or another size modifying virtual keyboard 110, by tapping any of the plurality of scaling-control-buttons 232. In some embodiments of the present invention, a plurality of the scaling-control-buttons 232 may be set by a user to present particular sizes of an exemplary virtual keyboard 110. The placements of a first scaling-control-tab 230, a second scaling-control-tab 234, and of the plurality of scaling-control-buttons 232 in these or other illustrations are purely for exemplary purposes, and other placements of these or other portions of the virtual keyboard 110 are to be understood as possible and desirable, as will be obvious to one of skill in the art.

In a preferred embodiment of the present invention, the scaling of a virtual keyboard 110 may be controlled by dedicated gestural touch commands, whether recognized by the system 800 only when the gestural touch commands are performed in the touchscreen area of the virtual keyboard 110, or at any location on the display 102. By way of example, without limiting the type or nature of any such gestural touch commands, the system 800 may be configured to recognize a two-point, three-point, or four-point pinch-or-spread gesture 240, as depicted in FIG. 2D, as a user input controlling the scaling of the virtual keyboard 110, based on the relative distance over which the user pinches or spreads the pinch-or-spread-gesture 240, or based on other relevant measures of the pinch-or-spread-gesture 240.

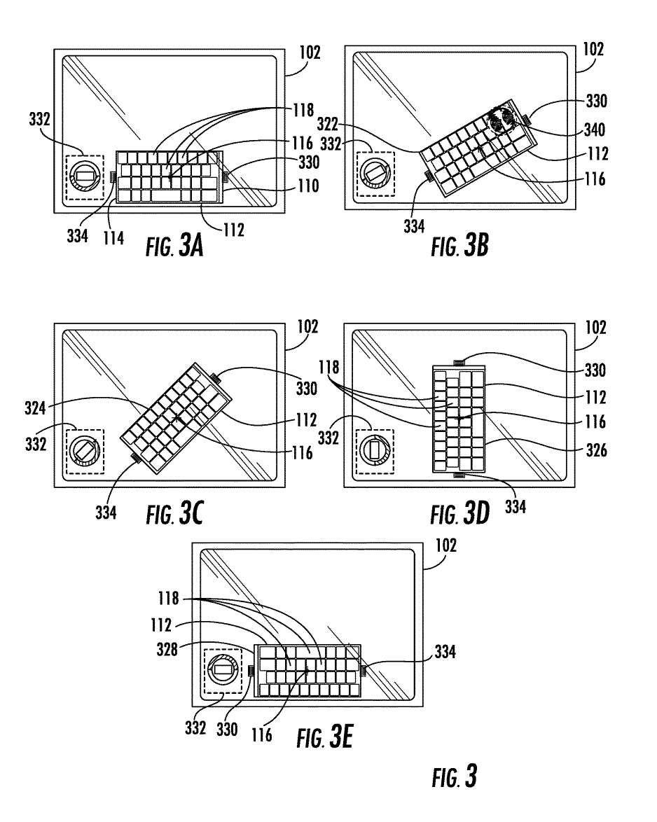

With reference to FIG. 3, an exemplary display 102 is shown with an exemplary virtual keyboard 110 in FIG. 3A, said virtual keyboard 110 being unrotated relative to the display 102. In a preferred embodiment of the invention, the virtual keyboard 110 may be rotated around the center point 116, or around a different reference point of the virtual keyboard 110 allowing a virtual rotation around an axis perpendicular to the display 102. Exemplary resulting rotations of the virtual keyboard 110 are shown by virtual keyboard 322 in FIG. 3B, virtual keyboard 324 in FIG. 3C, virtual keyboard 326 in FIG. 3D, and virtual keyboard 328 in FIG. 3E, all presented for exemplary purposes on an exemplary display 102.

With reference to each of FIGS. 3A-3E, the rotation of a virtual keyboard 110 may be controlled by a plurality of adjustment-input indications including but not limited to a first center-point-control-tab 330. In a preferred embodiment of the invention, the user of the virtual keyboard 110 uses a tap-and-drag gesture on the first center-point-control-tab 330 around the center point 116, or other reference point or points of the virtual keyboard 110 the advantages of which will be apparent to one of skill in the art, to move the first center-point-control-tab 330 on the display 102 relative to the center point 116 or other reference point of the virtual keyboard 110. The inventive system 800 calculates a new position for the virtual keyboard 110 based on the rotation around the center point 116 or other reference point of the virtual keyboard 110 of the first center-point-control-tab 330, from where the user first touched the first center-point-control-tab 330 to where the user positions or releases the first center-point-control-tab 330. The system 800 then rapidly re-displays the virtual keyboard 110 as virtual keyboard 322, virtual keyboard 324, virtual keyboard 326, virtual keyboard 328, or another rotational position modifying virtual keyboard 110. In other embodiments of the invention, the virtual keyboard 110 may comprise a second center-point-control-tab 334. A user may be able to rotate the virtual keyboard 110 by using either a first center-point-control-tab 330 or a second center-point-control-tab 334 in a manner similar to that described above for a first center-point-control-tab 330. In yet other embodiments of the present invention, a user may perform touch gestures on more than one of the first center-point-control-tab 330 and the second center-point-control-tab 334 simultaneously to rotate the virtual keyboard 110. It may be desirable to have a plurality of center-point-control-tabs.

In some embodiments of the present invention, the virtual keyboard 110 may further comprise a plurality of center-point-control-buttons 332, with each of the plurality of center-point-control-buttons 332 inputting to the system 800 a particular rotational position about the center point 116 of a modified virtual keyboard 110, allowing the user to rapidly choose between different rotational positions of an exemplary virtual keyboard, including but not limited to virtual keyboard 110, virtual keyboard 322, virtual keyboard 324, virtual keyboard 326, virtual keyboard 328, or another rotational position modifying virtual keyboard 110, by tapping any of the plurality of center-point-control-buttons 332. In some embodiments of the present invention, a plurality of the center-point-control-buttons 332 may be set by a user to present particular rotational positions of an exemplary virtual keyboard 110. The placements of a first center-point-control-tab 330, a second center-point-control-tab 334, and of the plurality of center-point-control-buttons 332 in these or other illustrations are purely for exemplary purposes, and other placements of these or other portions of the virtual keyboard 110 are to be understood as possible and desirable, as will be obvious to one of skill in the art.

In a preferred embodiment of the present invention, the rotation of a virtual keyboard 110 around the center point 116, or other reference point, may be controlled by dedicated gestural touch commands, whether recognized by the system 800 only when the gestural touch commands are performed in the touchscreen area of the virtual keyboard 110, or at any location on the display 102. By way of example, without limiting the type or nature of any such gestural touch commands, the system 800 may be configured to recognize a two-point rotational-gesture 340, as depicted in FIG. 3B, as a user input controlling the rotation of the virtual keyboard 110 around the center point 116, or other reference point, based on the degree of rotation of the user's rotational-gesture 340, or based on other relevant measures of the rotational-gesture 340.

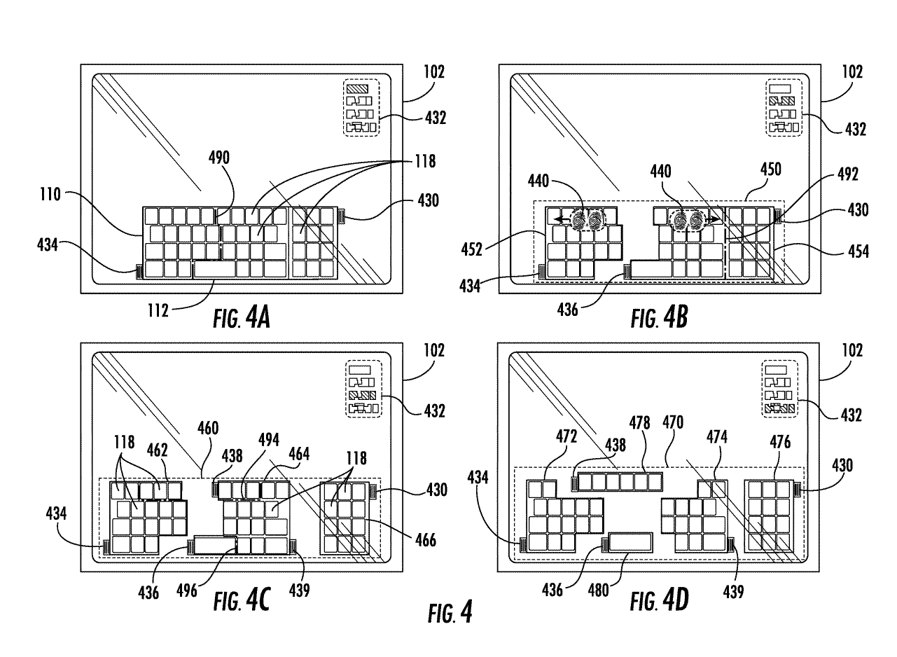

With reference to FIG. 4, an exemplary display 102 is shown with an exemplary virtual keyboard 110 in FIG. 4A, said virtual keyboard 110 being presented as one whole unit. In a preferred embodiment of the invention, the virtual keyboard 110 may be separated or divided into a plurality of component sub-units of a virtual keyboard 110. Exemplary resulting divisions of the virtual keyboard 110 into a plurality of component subunits of a virtual keyboard 110 are shown by virtual keyboard 450 in FIG. 4B, virtual keyboard 460 in FIG. 4C, and virtual keyboard 470 in FIG. 4D, all presented for exemplary purposes on an exemplary display 102. In FIG. 4B, the plurality of component subunits comprises a first component 452 and a second component 454. In FIG. 4C, the plurality of component subunits comprises a first component 462, a second component 464, and a third component 466. In FIG. 4D, the plurality of component subunits comprises a first component 472, a second component 474, a third component 476, a fourth component 478, and a fifth component 480. It will be understood by one of skill in the art that the foregoing representations of the number of components of a virtual keyboard 110 and their corresponding relative shapes and sizes, as depicted in FIGS. 4A-4D, are purely for illustrative purposes, and that any plurality of components of a virtual keyboard 110 may be implemented in any manner.

With reference to each of FIGS. 4A-4D, the division of a virtual keyboard 110 into a plurality of component subunits of a virtual keyboard 110 may be controlled by a plurality of adjustment-input indications, including but not limited to a plurality of division-control-tabs. In a preferred embodiment of the invention, the user of the virtual keyboard 110 uses a tap-and-drag gesture on a first division-control-tab 430 and a separate tap-and-drag gesture on a second division-control-tab 434 to move the first division-control-tab 430 relative to the second division-control-tab 434. The inventive system 800 calculates a division of the virtual keyboard 110 into a plurality of components, separating a first component 452 and a second component 454 along a first separation seam 490. The system 800 then rapidly re-displays the virtual keyboard 110 as a virtual keyboard comprising a plurality of a first component 452 and a second component 454, as depicted in FIG. 4B, and the system 800 may add additional division-control-tabs to the plurality of division-control-tabs, such as a third division-control-tab 436.

A user of the virtual keyboard 110 may then use separate tap-and-drag gestures on any plurality of the plurality of division-control-tabs, to further divide the presented plurality of components of the virtual keyboard 110 into additional components. As depicted in FIG. 4B, a user may use separate tap-and-drag gestures on a first division-control-tab 430 and on a third division-control-tab 436 to move the first division-control-tab 430 relative to the third division-control-tab 436. The inventive system 800 calculates the said division of the second component 454 along a second separation seam 492 into a plurality of components, separating a second component 454 into a second component 464 and a third component 466. The system 800 then rapidly re-displays the virtual keyboard 110 as a virtual keyboard comprising a plurality of a first component 462, a second component 464, and a third component 466, as depicted in FIG. 4C, and the system 800 may add additional division-control-tabs to the plurality of division-control-tabs, such as a fourth division-control-tab 438 and a fifth division-control-tab 439.

A user of the virtual keyboard 110 may then use separate tap-and-drag gestures on any plurality of the plurality of division-control-tabs, to further divide the presented plurality of components of the virtual keyboard 110 into additional components. As depicted in FIG. 4C, a user may use separate tap-and-drag gestures on a third division-control-tab 436 and on a fourth division-control-tab 438 and on a fifth division-control-tab 439 to move a said division-control-tabs relative to the other said division-control-tabs. The inventive system 800 calculates the said division of the second component 464 along a third separation seam 494 and along a fourth separation seam 496 into a plurality of components, separating a second component 464 into a second component 474, a fourth component 478, and a fifth component 480, as shown in FIG. 4D. The system 800 then rapidly re-displays the virtual keyboard 110 as a virtual keyboard 470 comprising a plurality of a first component 472, a second component 474, a third component 476, a fourth component 478, and a fifth component 480, as depicted in FIG. 4D, and the system 800 may add additional division-control-tabs to the plurality of division-control-tabs.

In some embodiments of the present invention, the plurality of adjustment-input indications of the virtual keyboard 110 may further comprise a plurality of division-control-buttons 432, with each of the plurality of division-control-buttons 432 inputting to the system 800 a particular division of an exemplary virtual keyboard 110 into a plurality of components, allowing the user to rapidly choose between different divisions of an exemplary virtual keyboard, including but not limited to virtual keyboard 110, virtual keyboard 450, virtual keyboard 460, virtual keyboard 470, or another division modifying virtual keyboard 110, by tapping any of the plurality of division-control-buttons 432. In some embodiments of the present invention, a plurality of the division-control-buttons 432 may be set by a user to present particular divisions of an exemplary virtual keyboard 110. The placements of any of a plurality of division-control-tabs in these or other illustrations are purely for exemplary purposes, and other placements of these or other portions of the virtual keyboard 110 are to be understood as possible and desirable, as will be obvious to one of skill in the art.

In a preferred embodiment of the present invention, the division of a virtual keyboard 110 into a plurality of components may be controlled by dedicated gestural touch commands, whether recognized by the system 800 only when the gestural touch commands are performed in the touchscreen area of the virtual keyboard 110, or at any location on the display 102. By way of example, without limiting the type or nature of any such gestural touch commands, the system 800 may be configured to recognize a four-point-pinch-or-spread-gesture 440, as depicted in FIG. 4B, as a user input controlling the division of the virtual keyboard 110 into a plurality of components, based on the relative starting points and end points of the user's four-point-pinch-or-spread-gesture 440. When implementing such a four-point-pinch-or-spread-gesture 440, the system 800 may divide the virtual keyboard 110 along any of the plurality of a first separation seam 490, a second separation seam 492, a third separation seam 494, and a fourth separation seam 496, or along other similar separation seams, as will be evident to one of skill in the art. It will also be evident to one of skill in the art that the system 800 can join any of a plurality of components into a smaller number of a plurality of components or into a single whole virtual keyboard 110 by receiving appropriate input of moving a plurality of division-control-tabs nearer to or onto a plurality of division-control-tabs, or with appropriate input of a four-point-pinch-or-spread-gesture 440, or from appropriate selections from a plurality of division-control-buttons 432.

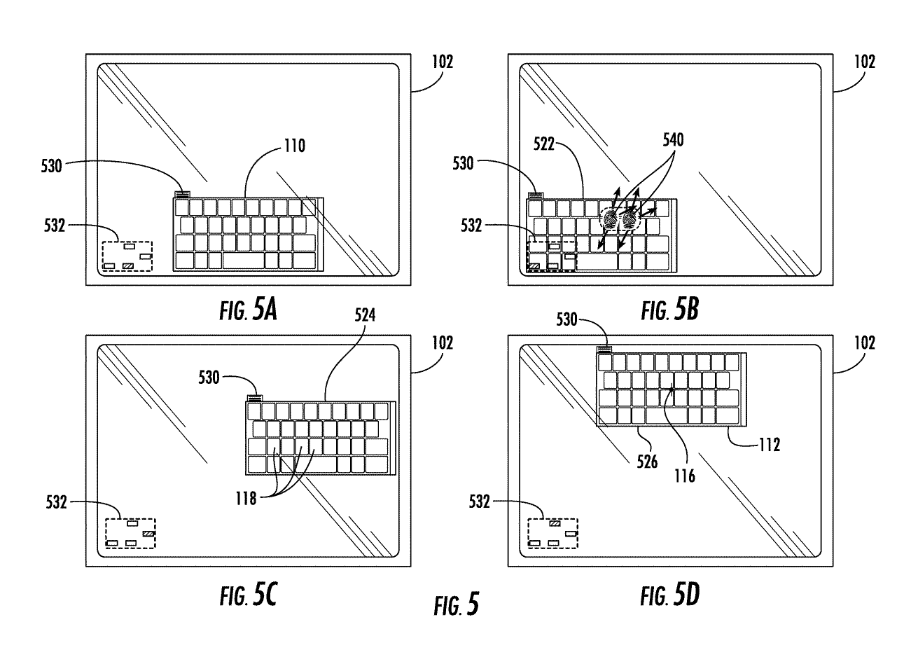

With reference to FIG. 5, an exemplary display 102 is shown with an exemplary virtual keyboard 110 in FIG. 5A, said virtual keyboard 110 being presented at a typical starting location, referred to in the present disclosure as untranslated, relative to the display 102. In a preferred embodiment of the invention, the virtual keyboard 110 may be translated, or moved, relative to the display 102. Exemplary resulting translations of the virtual keyboard 110 are shown by virtual keyboard 522 in FIG. 5B, virtual keyboard 524 in FIG. 5C, and virtual keyboard 526 in FIG. 5D, all presented for exemplary purposes on an exemplary display 102.

With reference to each of FIGS. 5A-5D, the translation of a virtual keyboard 110 may be controlled by a plurality of adjustment-input indications, including but not limited to a first translation-control-tab 530. In a preferred embodiment of the invention, the user of the virtual keyboard 110 uses a tap-and-drag gesture on the first translation-control-tab 530 to move the first translation-control-tab 530 on the display 102 relative to the virtual keyboard 110. The inventive system 800 calculates a new position for the virtual keyboard 110 based on the translation of the first translation-control-tab 530, from where the user first touched the first translation-control-tab 530 to where the user positions or releases the first translation-control-tab 530. The system 800 then rapidly re-displays the virtual keyboard 110 as virtual keyboard 522, virtual keyboard 524, virtual keyboard 526, or another translational position modifying virtual keyboard 110. It may be desirable to have a plurality of translation-control-tabs.

In some embodiments of the present invention, the virtual keyboard 110 may further comprise a plurality of translation-control-buttons 532, with each of the plurality of translation-control-buttons 532 inputting to the system 800 a particular translational position of a modified virtual keyboard 110, allowing the user to rapidly choose between different translational positions of an exemplary virtual keyboard, including but not limited to virtual keyboard 110, virtual keyboard 522, virtual keyboard 524, virtual keyboard 526, or another translational position modifying virtual keyboard 110, by tapping any of the plurality of translation-control-buttons 532. In some embodiments of the present invention, a plurality of the center translation-control-buttons 532 may be set by a user to present particular translational positions of an exemplary virtual keyboard 110. The placements of a first translation-control-tab 530 and of the plurality of translation-control-buttons 532 in these or other illustrations are purely for exemplary purposes, and other placements of these or other portions of the virtual keyboard 110 are to be understood as possible and desirable, as will be obvious to one of skill in the art.

In a preferred embodiment of the present invention, the translation of a virtual keyboard 110 relative to the display 102 may be controlled by dedicated gestural touch commands, whether recognized by the system 800 only when the gestural touch commands are performed in the touchscreen area of the virtual keyboard 110, or at any location on the display 102. By way of example, without limiting the type or nature of any such gestural touch commands, the system 800 may be configured to recognize a two-point translational-gesture 540, as depicted in FIG. 5B, as a user input controlling the translation of the virtual keyboard 110 on the display 102 based on the start and end locations of the user's translational-gesture 540, or based on other relevant measures of the translational-gesture 540.

It will be understood by one of skill in the art that any of the plurality of adjustment-input indications, including but not limited to first-edge-control-tab 130, first scaling-control-tab 230, second scaling-control-tab 234, first center-point-control-tab 330, second center-point-control-tab 334, any of the plurality of division-control-tabs (comprising a first division-control-tab 430, a second division-control-tab 434, a third division-control-tab 436, a fourth division-control-tab 438, a fifth division-control-tab 439, and other possible division-control-tabs), and a first translation-control-tab 530 (said plurality of control tabs collectively referred to herein as the control tabs), may have a plurality of their respective controls combined, such that any of the plurality of aforementioned control tabs may serve to control one or more of the above functions of the present invention, including but not limited to rotations, scaling, divisions, or translations. Similarly, any of the plurality of adjustment-input indications including but not limited to first-edge-control-buttons 132, scaling-control-buttons 232, center-point-control-buttons 332, division-control-buttons 432, or translation-control-buttons 532 (said plurality of buttons collectively referred to herein as the control buttons) can be combined such that they are implemented as combination presets by the system 800, or combined as user-definable combinations, or combined with any of the plurality of aforementioned buttons overlaid on top of others in the plurality of aforementioned buttons, such that any of the sets of control buttons may be toggled between by a user, in the same space on or near to the presentation of the virtual keyboard 110. Furthermore, any of the plurality of gestural touch commands, including but not limited to a touch-and-drag gesture 140, a pinch-or-spread gesture 240, a rotational-gesture 340, a four-point-pinch-or-spread-gesture 440, and a translational-gesture 540 (said plurality of buttons collectively referred to herein as the gestural touch commands) can be combined or carried out simultaneously or in near sequence by a user, such that a user may translate and rotate a presentation of a virtual keyboard 110, or carry out other combinations of adjustments, simultaneously or near-simultaneously.

It will be understood by one of skill in the art that in presentations of a virtual keyboard 110 where the virtual keyboard 110 is divided into a plurality of components, any of the foregoing adjustments or combinations of adjustments may be applied to each of the said components, either separately from each of the other said components, or in a manner that links the plurality of said components. For example, without limiting the foregoing, a virtual keyboard 110 divided into two components may have each component, or either component, rotated around the center point 116 of the virtual keyboard 110, or each of the said components may be separately rotated about a plurality of other reference points, including but not limited to the respective center points of said components, and the direction of rotation for each said component may be the same or may be different, resulting in a virtual keyboard resembling a classic split ergonomic keyboard. By way of further illustration, without limiting any of the foregoing, in any such presentation of an exemplary virtual keyboard, said components may be separately, or in a linked manner, translated on an exemplary display 102, or rotated about a first edge 112 of the exemplary virtual keyboard 110 or about another relevant edge or reference point of each said component.

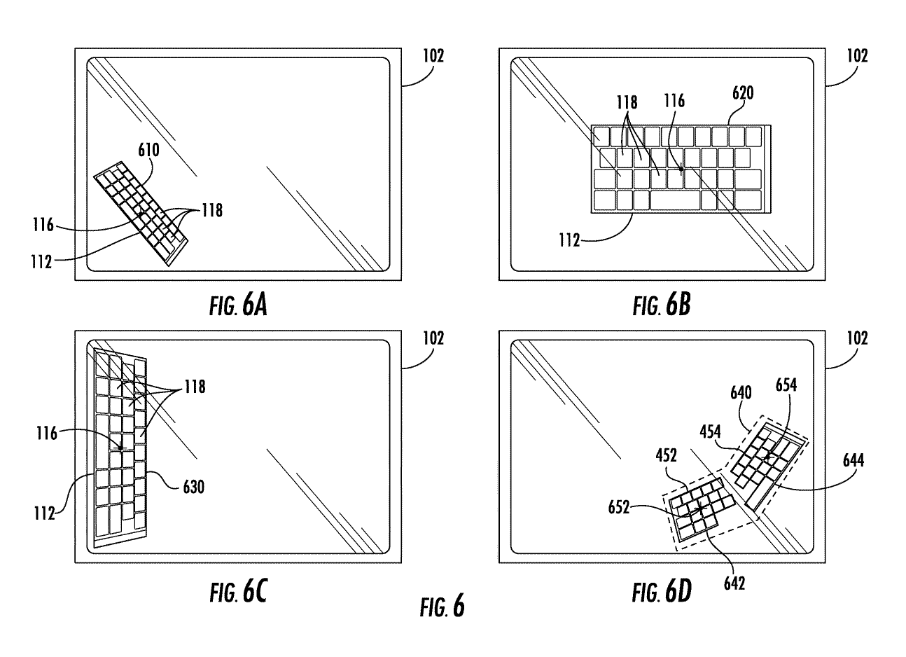

With reference to FIG. 6, FIGS. 6A-6D show multiple views of exemplary virtual keyboards on a display 102. The plurality of virtual keyboards, as depicted in FIGS. 6A-6D, may be adjusted by a user to be presented by the system 800 in a variety of perspectives with rotation around a first edge, sizes with scaling, rotation around a center point of said virtual keyboard, division into a plurality of components of said virtual keyboard, and translational positions on the exemplary display.

FIG. 6A depicts an exemplary virtual keyboard 610 translated to be presented near a corner of the display 102, adjacent to a typical starting edge location of a virtual keyboard 110. Virtual keyboard 610 is presented at a standard size as one unit, not divided into components, and virtual keyboard 610 is presented with a small amount of rotation about a first edge 112 and a small amount of rotations around the center point 116.

FIG. 6B illustrates an exemplary virtual keyboard 620 translated towards the middle of an exemplary display 102, and scaled to a larger size, but presented in one unit not divided into components, and not rotated about a first edge 112 or around the center point 116.

FIG. 6C illustrates an exemplary virtual keyboard 630 translated to be placed away from a first edge of an exemplary display 102 and along a second edge of said exemplary display 102, not scaled to a smaller size, presented in one unit not divided into components, and rotated about a first edge 112 to be presented in perspective, and rotated around the center point 116 to align flush with the said second edge of said exemplary display 102.

FIG. 6D depicts an exemplary virtual keyboard 640 translated to be presented near to a corner of an exemplary display 102, not scaled to a different size, and separated into a plurality of components, here illustrated as a first component 452 and a second component 454. Said first component 452 is presented as rotated about a first-component first edge 642 and said second component 454 is presented as rotated about a second-component first edge 644. Said rotations about said first-component first edge 642 and said second-component first edge 644 are depicted in FIG. 6D as equivalent, though they could be different degrees of virtual rotation. Said first component 452 is further presented as rotated about a first-component center point 652 and said second component 454 is further presented as rotated about a second-component center point 654. Said rotations about said first-component center point 652 and said second-component center point 654 are depicted in FIG. 6D as equivalent in degree of rotation and opposite in direction of rotation, reproducing in virtual keyboard 640 the appearance of a typical split ergonomic keyboard. Any of the foregoing rotations, translations, or divisions of virtual keyboard 640 or other inventive virtual keyboard could be adjusted by a user, as will be apparent to one of skill in the art. Virtual keyboard 640 is presented in total as angled along a corner of an exemplary display 102.

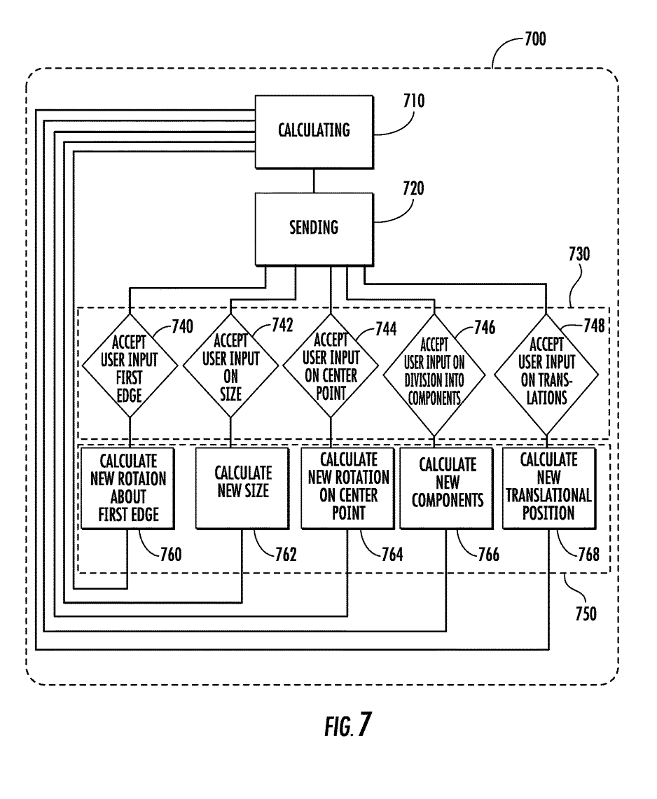

FIG. 7 depicts an exemplary method 700 of generating, presenting, and adjusting a virtual keyboard. The inventive method 700 comprises the steps of calculating 710 a first presentation of an exemplary virtual keyboard 110, sending 720 the calculated presentation of the exemplary virtual keyboard 110 to an exemplary display 102, accepting a plurality of user inputs 730 for a plurality of adjustments to the calculated presentation of the exemplary virtual keyboard 110, making a plurality of calculations 750 related to a plurality of the adjustments referred to herein as the user modifications, and iteratively calculating 710 a next presentation of an exemplary virtual keyboard 110.

Calculating 710 a first presentation of an exemplary virtual keyboard 110 requires the system 800 to draw upon default or initial display parameters for an exemplary virtual keyboard 110. Such default or initial display parameters may be stored in the computer-readable instructions 840. Once the system 800 has calculated the initial display parameters of an exemplary virtual keyboard 110, the system 800 engages in sending 720 the display parameters to an exemplary display 102 for presentation of the exemplary virtual keyboard 110.

Upon display of an exemplary virtual keyboard 110, a user may engage with the system 800 and enter control inputs using any of the aforementioned control tabs, control buttons, gestural touch commands, or other means now known or later invented. For instance, without limiting the foregoing, a user may enter control inputs for rotation about a first edge 112 using a first-edge-control-tab 130; at such time the system 800 would accept the user-first-edge-input 740 and would then calculate a next-first-edge-rotation 760. Without limiting the foregoing, a user may enter control inputs for scaling the size of a virtual keyboard 110 using a plurality of scaling-control-buttons 232; at such time the system 800 would accept the user-scaling-input 742 and would then calculate a next-scaling-size 762. Likewise, without limiting the foregoing, a user may enter control inputs for rotating an exemplary virtual keyboard 110 around the center point 116 of a virtual keyboard 110 using a plurality of center-point-control-buttons 332; at such time the system 800 would accept the user-center-point-rotation-input 744 and would then calculate a next-center-point-rotation 764.

Next, without limiting the foregoing, a user may enter control inputs for dividing an exemplary virtual keyboard 110 into a plurality of components of a virtual keyboard 110 using a plurality of four-point-pinch-or-spread-gestures 440; at such time the system 800 would accept the user-component-division-input 746 and would then calculate a next-component-division 766. Additionally, without limiting the foregoing, a user may enter control inputs for translating an exemplary virtual keyboard 110 relative to an exemplary display 102 using a plurality of translation-control-buttons 532; at such time the system 800 would accept the user-translation-input 748 and would then calculate a next-translation-position 768.

The step of accepting a plurality of user inputs 730 comprises the system 800 accepting a plurality of the user-first-edge-input 740, user-scaling-input 742, the user-center-point-rotation-input 744, the user-component-division-input 746, and the user-translation-input 748. The step of making a plurality of calculations 750 comprises the system 800 calculating a plurality of a next-first-edge-rotation 760, a next-scaling-size 762, a next-center-point-rotation 764, a next-component-division 766, and a next-translation-position 768. After completing any of the plurality of calculations comprising making a plurality of calculations 750, the system 800 continues with iteratively calculating 710 a next presentation of an exemplary virtual keyboard 110.

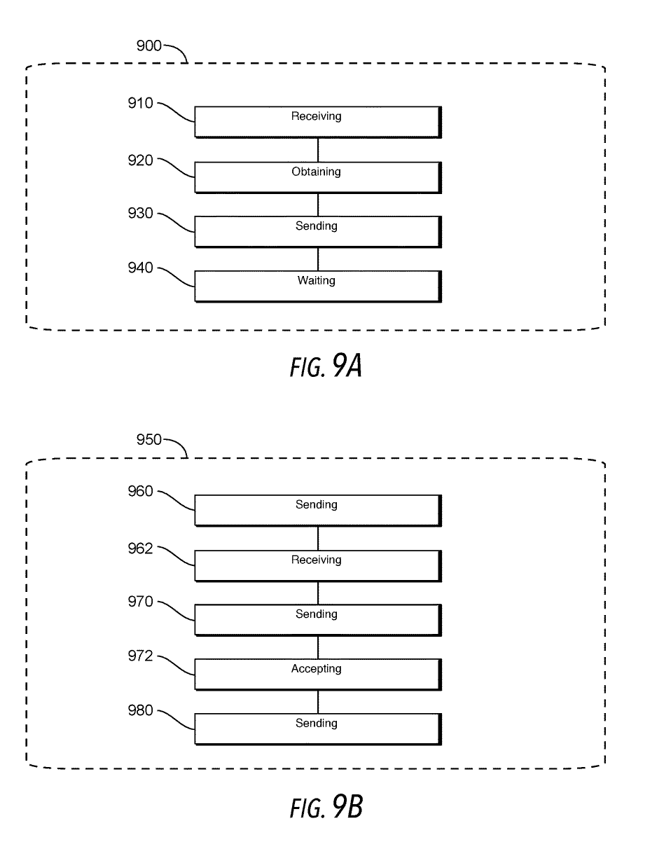

FIG. 9A depicts an exemplary method 900 of generating, presenting, and adjusting a virtual keyboard from the perspective of an input device 850 in operative communication with the inventive system 800, whether that input device 850 is internal to or external to the inventive system 800. The method 900 comprises the steps of an input device 850 receiving 910 a calculated presentation of an exemplary virtual keyboard 110, then the input device 850 obtaining 920 a plurality of user inputs 730 for a plurality of adjustments to the calculated presentation of the exemplary virtual keyboard 110, then the input device 850 sending 930 the plurality of user inputs 730 to a processor 810; and then the input device 850 waiting 940 for a next presentation of the virtual keyboard 110. The input device 850 may be any input device 850, as described below. The plurality of user inputs 730 may comprise any of the user inputs described in the present disclosure. The method 900 may be stored in computer-readable media 830.

FIG. 9B depicts an exemplary method 950 of generating, presenting, and adjusting a virtual keyboard from the perspective of a third party external to a system 800 and an input device 850. The method 950 comprises the steps of the system 800 sending 960 to an input device 850 a calculated presentation of a virtual keyboard 110; then the input device 850 receiving 962 the calculated presentation of the virtual keyboard 110; then the input device 850 sending 970 to the system 800 a plurality of user inputs 730 for a plurality of adjustments to the calculated presentation of the virtual keyboard 110; then the system 800 accepting 972 the plurality of user inputs 730; then the system 800 sending 980 a next presentation of the virtual keyboard 110 to the input device 850. The input device 850 may be any input device 850, as described below, and the system 800 may be any system as described herein. The plurality of user inputs 730 may comprise any of the user inputs described in the present disclosure. The method 900 may be stored in computer-readable media 830.

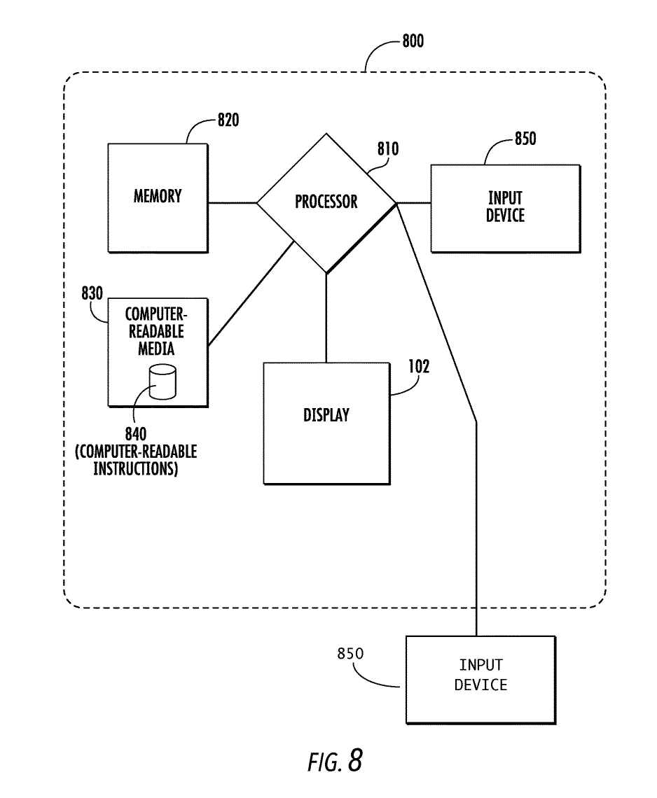

FIG. 8 shows an exemplary system 800 configured to carry out the methods 700 of the present invention to generate, present, and adjust an exemplary virtual keyboard. The system 800 comprises a plurality of processors 810, a plurality of memories 820, a plurality of displays 102, a plurality of computer-readable media 830 for storing a plurality of computer-readable instructions 840, and a plurality of input devices 850 for delivering control inputs by the user to the system 800.

The processor 810 carries out the step of calculating 710 the presentation of an exemplary virtual keyboard 110, drawing on the plurality of computer-readable media 830 and computer-readable instructions 840 to obtain information to generate an exemplary virtual keyboard 110, and using the memory 820 to store information while processing the computer-readable instructions 840. The system 800 then carries out the step of sending 720 information on the presentation of said virtual keyboard 110 to a plurality of displays 102. The display 102 referred to here may be a touchscreen display of the sort illustrated in FIGS. 1-6, or may be a different type of display now known or later invented.

Once an exemplary virtual keyboard 110 is presented to a user on a display 102, the system 800 can begin the step of accepting a plurality of user inputs 730, using a plurality of input devices 850. Said input devices 850 may include, but are not limited to, a touchscreen display, a remote control, a dedicated keypad, number pad, or button pad, or other physical controls built into or external to the system 800 for purposes of delivering user input to the system 800. As a user makes adjustments to the virtual keyboard 110, the system 800 carries out the step of making a plurality of calculations 750 based on the input received from the user with the input device 850. The system 800 processes said input received from the user with the processor 810, storing results in the memory 820. The system 800 then uses said user input information, along with computer-readable instructions 840, to carry out the step of iteratively calculating 710 the presentation of an exemplary virtual keyboard 110 as adjusted in response to said user input information and iteratively sending 720 the adjusted display parameters to said plurality of displays 102 for presentation of the exemplary adjusted virtual keyboard 110. The plurality of input devices 850 may include input devices 850 internal to the system 800 and/or input devices 850 external to the system 800.

The various modules and/or functions described above may be implemented by computer-executable instructions, such as program modules, executed by a conventional computer. Generally, program modules include routines, programs, objects, components, data structures, etc. that perform particular tasks or implement particular abstract data types. Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer-storage media including memory storage devices.

The central computing device may comprise or consist of a general-purpose computing device in the form of a computer including a processing unit, a system memory, and a system bus that couples various system components including the system memory to the processing unit. Computers typically include a variety of computer-readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by the processing unit. The data or program modules may include an operating system, application programs, other program modules, and program data. The operating system may be or include a variety of operating systems such as Microsoft WINDOWS operating system, the Unix operating system, the Linux operating system, the Xenix operating system, the IBM AIX operating system, the Hewlett Packard UX operating system, the Novell NETWARE operating system, the Sun Microsystems SOLARIS operating system, the OS/2 operating system, the BeOS operating system, the MACINTOSH operating system, the APACHE operating system, the iOS operating system, the Android operating system, the Chrome operating system, an OPENSTEP operating system or another operating system or platform.

Any suitable programming language may be used to implement without undue experimentation the data-gathering and analytical functions described above. Illustratively, the programming language used may include assembly language, Ada, APL, Basic, C, C++, C*, COBOL, dBase, Forth, FORTRAN, Java, Modula-2, Pascal, Prolog, Python, Qt, REXX, and/or JavaScript for example. Further, it is not necessary that a single type of instruction or programming language be utilized in conjunction with the operation of the system and method of the invention. Rather, any number of different programming languages may be utilized as is necessary or desirable.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD-ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

The network over which communication takes place may include a wired or wireless local area network (LAN) and a wide area network (WAN), wireless personal area network (PAN) and/or other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Certain embodiments of the present invention were described above. From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A method, stored in computer-readable media, for generating and presenting adjustable virtual keyboards, and for accepting inputs from users for adjusting and recalculating the virtual keyboard, and recalculating the virtual keyboard to comply with the inputs from a user, and presenting the adjusted virtual keyboard, from the perspective of a processor in the inventive system, the method comprising:
a processor calculates a first presentation of a virtual keyboard; then the processor sends the calculated presentation of the virtual keyboard to a display; then
the processor waits for and accepts a plurality of user inputs for a plurality of adjustments to the calculated presentation of the virtual keyboard from a user indicating a desired adjustment; then
upon receiving an input for a desired adjustment, the processor makes a plurality of calculations related to a plurality of the adjustments; and then the processor iteratively calculates a next presentation of the virtual keyboard.

2. The method of claim 1, in which the plurality of user inputs may comprise gestural touch commands.

3. The method of claim 1, in which the virtual keyboard comprises a plurality of adjustment-input indications, which adjustment-input indications correspond to a plurality of adjustments.

4. The method of claim 1, in which the plurality of adjustments includes, but is not limited to:
rotation about a first edge;
rotation about a second edge;
rotation about a center point;
translation for location on the display;
scaling for size of the virtual keyboard; and/or
splitting the virtual keyboard into one or more subunits.

5. The method of claim 3, in which for a possible adjustment of rotation about a first edge, the plurality of adjustment-input indications comprises a first-edge-control-tab, a plurality of first-edge-control-buttons, or both a first-edge-control-tab and a plurality of first-edge-control-buttons.

6. The method of claim 3, in which for a possible adjustment of scaling for size, the plurality of adjustment-input indications comprises a plurality of scaling-control-tabs, a plurality of scaling-control-buttons, or both a plurality of scaling-control-tabs and a plurality of scaling-control-buttons.

7. The method of claim 3, in which for a possible adjustment of rotation about a center point, the plurality of adjustment-input indications comprises a plurality of center-point-control-tabs, a plurality of center-point-control-buttons, or both a plurality of center-point-control-tabs and a plurality of center-point-control-buttons.

8. The method of claim 3, in which for a possible adjustment of splitting the virtual keyboard into one or more subunits, the plurality of adjustment-input indications comprises a plurality of division-control-tabs, a plurality of division-control-buttons, or both a plurality of division-control-tabs and a plurality of division-control-buttons.

9. The method of claim 3, in which for a possible adjustment of translation for location on the display, the plurality of adjustment-input indications comprises a plurality of translation-control-tabs, a plurality of translation-control-buttons, or both a plurality of translation-control-tabs and a plurality of translation-control-buttons.

10. A method, stored in computer-readable media, for generating and presenting adjustable virtual keyboards, and for accepting inputs from users for adjusting and recalculating the virtual keyboard, and recalculating the virtual keyboard to comply with the inputs from a user, and presenting the adjusted virtual keyboard, from the perspective of an input device in operative communication with the inventive system, the method comprising:
the input device receiving a calculated presentation of a virtual keyboard;
then
the input device obtaining a plurality of user inputs for a plurality of adjustments to the calculated presentation of the exemplary virtual keyboard; then
the input device sending the plurality of user inputs to a processor; and
then
the input device waits for a next presentation of the virtual keyboard.

11. The method of claim 10, in which the plurality of user inputs may comprise gestural touch commands.

12. The method of claim 10, in which the virtual keyboard comprises a plurality of adjustment-input indications, which adjustment-input indications correspond to a plurality of adjustments.

13. The method of claim 10, in which the plurality of adjustments includes, but is not limited to:
rotation about a first edge;
rotation about a second edge;
rotation about a center point;
translation for location on the display;
scaling for size of the virtual keyboard; and/or
splitting the virtual keyboard into one or more subunits.

14. A method, stored in computer-readable media, for generating and presenting adjustable virtual keyboards, and for accepting inputs from users for adjusting and recalculating the virtual keyboard, and recalculating the virtual keyboard to comply with the inputs from a user, and presenting the adjusted virtual keyboard, from the perspective of a third party external to a system and an input device, the method comprising:
the system sending to the input device a calculated presentation of a virtual keyboard; then
the input device receiving the calculated presentation of the virtual keyboard; then
the input device sending to the system a plurality of user inputs for a plurality of adjustments to the calculated presentation of the virtual keyboard;
then the system accepting the plurality of user inputs; then
the system sending a next presentation of the virtual keyboard to the input device.

15. The method of claim 14, in which the plurality of user inputs may comprise gestural touch commands.

16. The method of claim 14, in which the virtual keyboard comprises a plurality of adjustment-input indications, which adjustment-input indications correspond to a plurality of adjustments.

17. The method of claim 14, in which the plurality of adjustments includes, but is not limited to:
rotation about a first edge;
rotation about a second edge;
rotation about a center point;
translation for location on the display;
scaling for size of the virtual keyboard; and/or
splitting the virtual keyboard into one or more subunits.

18. A system of communicably connected components for generating and presenting adjustable virtual keyboards, and for accepting inputs from users for adjusting and recalculating the virtual keyboard, and recalculating the virtual keyboard to comply with the inputs from a user, and presenting the adjusted virtual keyboard, the system comprising:
a plurality of processors;
a plurality of memories;
a plurality of displays;
a plurality of computer-readable media capable of storing computer-readable instructions;
a plurality of computer-readable instructions, and
a plurality of input devices capable of delivering control inputs from the user to the system.

19. The system of claim 18, in which the system is communicably connected to a plurality of input devices external to the system.

20. Computer-readable instructions, stored in computer-readable media, for generating and presenting adjustable virtual keyboards, and for accepting inputs from users for adjusting and recalculating the virtual keyboard, and recalculating the virtual keyboard to comply with the inputs from a user, and presenting the adjusted virtual keyboard.
